(19) United States
(12) Patent Application Publication
(10) Pub. No.: US 2024/0254024 A1
(43) Pub. Date: Aug. 1, 2024

(54) WATER TREATMENT METHOD, WATER TREATER, AND PURE WATER PRODUCTION SYSTEM

(71) Applicant: Nomura Micro Science Co., Ltd., Atsugi-shi (JP)

(72) Inventors: Yukio NOGUCHI, Atsugi-shi (JP); Yoshihiro AKIMOTO, Atsugi-shi (JP)

(73) Assignee: Nomura Micro Science Co., Ltd., Atsugi-shi (JP)

(21) Appl. No.: 18/427,888

(22) Filed: Jan. 31, 2024

(30) Foreign Application Priority Data
Feb. 1, 2023 (JP) 2023-014292

(51) Int. Cl. C02F 1/70; C02F 1/32; C02F 1/68; C02F 101/34; C02F 101/38; C02F 103/04

(52) U.S. Cl. CPC C02F 1/70; C02F 1/325; C02F 1/686; C02F 2101/34; C02F 2101/38; C02F 2103/04

(57) ABSTRACT

In a water treatment method, a reducing agent injector adds a reducing agent to water to be treated, and an ultraviolet irradiater irradiates the water to be treated to which the reducing agent has been added with ultraviolet rays to decompose urea.

### CROSS-REFERENCE TO RELATED APPLICATION

This application claims the benefit of priority of Japan Patent Application No. 2023-14292 filed on Feb. 1, 2023, the contents of which are incorporated by reference as if fully set forth herein in their entirety.

### BACKGROUND

### Technical Field

The present disclosure relates to a water treatment method, a water treater, and a pure water production system.

### Related Art

Japanese Patent Application Laid-Open (JP-A) No. H03-278882 describes, as a method of removing dissolved oxygen in water, a configuration in which a reducing agent is dissolved in water in which oxygen is dissolved and ultraviolet rays are irradiated.

Incidentally, it is desirable that urea is removed from pure water (including ultrapure water) used in a semiconductor producer or the like.

However, the technique described in Japanese Patent Application Laid-Open (JP-A) No. H03-278882 is a method of removing dissolved oxygen in water, and does not remove urea in water to be treated.

In order to decompose urea in the water to be treated, for example, a method of separating urea by passing the water to be treated through a filtration membrane such as a reverse osmosis membrane is considered. A decomposition method using ultraviolet irradiation or an oxidizing agent such as peroxosulfuric acid is also conceivable. However, in any of these methods, it is difficult to sufficiently remove urea from the water to be treated, and it is desired to remove urea at a higher urea removal rate. When an oxidizing agent is added, some of the oxidizing agent added in a large amount remains in the water to be treated, which may cause deterioration in a membrane device or an ion exchanger provided at a subsequent stage of a urea treater. Therefore, it is also necessary to treat the oxidizing agent with a reducing agent.

### SUMMARY

In a water treatment method according to an aspect of the disclosure, a reducing agent injector(blender, adder) adds a reducing agent to water to be treated, and an ultraviolet irradiater irradiates the water to be treated to which the reducing agent has been added with ultraviolet rays to decompose urea.

### BRIEF DESCRIPTION OF THE DRAWINGS

Exemplary embodiments of the present disclosure will be described in detail based on the following figures, wherein:

FIG. 1 is a configuration diagram illustrating an ultrapure water production system including a water treater according to a first embodiment;

FIG. 2 is a configuration diagram illustrating the water treater according to the first embodiment;

FIG. 3 is a graph illustrating a relationship between a dissolved oxygen amount of water to be treated and a urea removal rate; and

FIG. 4 is a graph illustrating a relationship between a pH of water to be treated and a urea removal rate.

### DETAILED DESCRIPTION

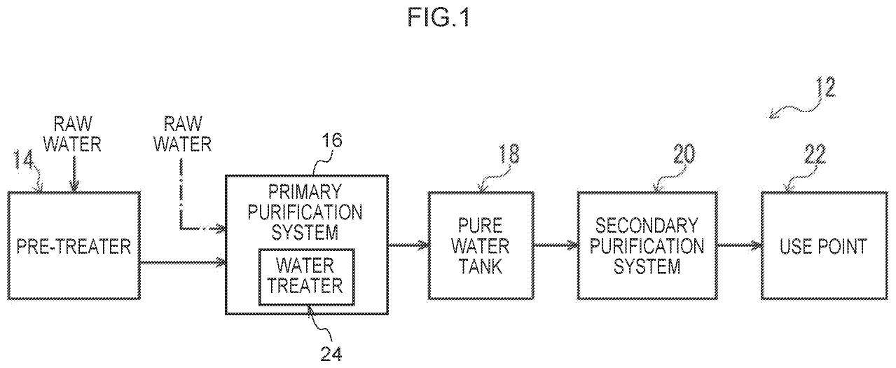

Hereinafter, a water treater 24 and an ultrapure water production system 12 according to a first embodiment will be described with reference to the drawings. As illustrated in FIG. 1, the ultrapure water production system 12 has a pre-treater 14, a primary purification system (deionized water production system, demineralizer) 16, a pure water tank 18, a secondary purification system (deionized water production system, demineralizer) 20, and a use point 22. The ultrapure water production system 12 is a system that removes impurities and the like from raw water to produce ultrapure water. Examples of the raw water include industrial water, tap water, groundwater, river water, and the like.

The raw water is supplied to the pre-treater 14. In the pre-treater 14, pretreated water obtained by removing some of suspended substances and organic substances from the raw water is obtained by performing a treatment such as turbidity removal using activated carbon. Depending on the water quality of the raw water, the pre-treater 14 may be omitted and the raw water may be sent to the primary purification system 16 as indicated by a one-dot chain line in FIG. 1. As the pre-treater, a sand filter, a pressure floater, or the like may be provided.

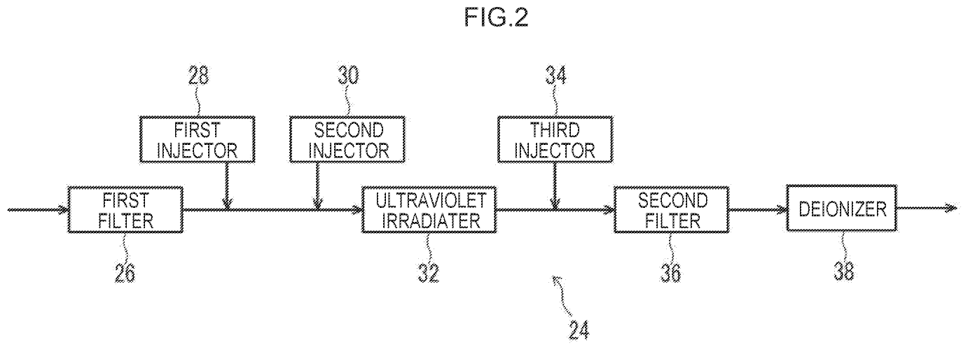

The primary purification system 16 has the water treater 24. As illustrated in FIG. 2, the water treater 24 has a first filter 26, a first injector(blender, adder) 28, a second injector(blender, adder) 30, an ultraviolet irradiater 32, a third injector(blender, adder) 34, a second filter 36, and a deionizer 38.

The first filter 26 includes a reverse osmosis membrane therein. The first filter 26 filters the water to be treated. As a result, some of foreign substances in the water to be treated is removed. Therefore, in a urea decomposition in a subsequent stage, it is possible to suppress deterioration of urea removal performance due to occurrence of side reactions. The first filter 26 is not an essential component, and can be omitted, for example, depending on the water quality of the raw water.

The first injector 28 can add a pH adjusting agent to the water to be treated that has passed through the first filter 26. In the technique of the disclosure, NaOH, HCL, or H₂SO₄ may be used as the pH adjusting agent to adjust the pH to a pH suitable for decomposition of urea. For example, when the pH of the water to be treated is in a range from 5 to 6 before addition of NaOH, the pH is in a range from 6 to 8 after addition of NaOH. However, when the water to be treated is alkaline even in a state where the pH adjusting agent is not added, the addition of the pH adjusting agent is unnecessary.

A decarbonizer may be provided at a front stage of the first injector 28. By providing the decarbonizer, inhibition of urea decomposition by carbonic acid can be suppressed. As the decarbonizer, it is possible to use an atmospheric pressure degasser and a reverse osmosis membrane device operating at a pH of 8 or more. This decarbonizer can also be installed at the front stage of the first filter 26 or between the first injector 28 and the ultraviolet irradiater 32. Instead of the first filter 26 and the decarbonizer, a two-bed three-tower desalinater (2B3T tower) can be installed.

The second injector 30 can add a reducing agent to the water to be treated to which the pH adjusting agent has been added. In the present embodiment, sodium sulfite (Na₂SO₃), sodium bisulfite (NaHSO₃), or sodium sulfamate (NH₂OSO₂Na) is used as the reducing agent. Each of sodium sulfite, sodium bisulfite, and sodium sulfamate includes a sulfur atom. The second injector 30 is an example of a reducing agent injector. The arrangement order of the first injector 28 and the second injector 30 may be reversed, or a system in which a pH adjusting agent and a reducing agent are substantially simultaneously added may be adopted.

The ultraviolet irradiater 32 accelerates oxidative decomposition by irradiating the water to be treated to which the reducing agent has been added with ultraviolet rays. The wavelength of the ultraviolet rays may be any wavelength as long as it can oxidize the water to be treated. For example, the ultraviolet rays may be ultraviolet rays having a wavelength of about 185 nm generally used for ultraviolet oxidation, or may be ultraviolet rays having a wavelength of about 254 nm used for sterilization.

It is considered that the reducing agent added to the water to be treated is changed to a persulfuric acid radical or an oxidizing agent having a form close thereto by the action of ultraviolet rays. Then, urea is decomposed by the generated oxidizing agent.

The third injector 34 can add a reducing agent to the water to be treated that has been irradiated with ultraviolet rays. In the present embodiment, sodium sulfite (Na₂SO₃), sodium bisulfite (NaHSO₃), or sodium sulfamate (NH₂OSO₂Na) is used as the reducing agent similarly to the second injector 30. As described above, an oxidizing agent is generated by ultraviolet irradiation. Hydrogen peroxide is also generated by ultraviolet irradiation. Even when these oxidizing agents remain in the water to be treated, the water to be treated is subjected to a reduction treatment by the reducing agent. The amount of the oxidizing agent generated by the ultraviolet irradiation is a minimum amount of the oxidizing agent necessary for decomposition of urea, and the amount of the oxidizing agent remaining is also small. Therefore, it is also possible to omit the addition of the oxidizing agent at this stage.

Similarly to the first filter 26, the second filter 36 includes a reverse osmosis membrane therein. Then, the second filter 36 filters the water to be treated, whereby some of foreign substances in the water to be treated is further removed.

The water treater 24 further includes a deionizer 38 on a downstream side of the second filter 36. The deionizer 38 removes remaining ions and the like from the water to be treated by ion exchange. However, depending on a type and a state of the water to be treated, a configuration in which a deionization treatment is not performed may be adopted. Examples of the deionizer include, but are not limited to, an electrically regeneration-type ion exchanger, a mixed-bed ion exchanger (MB tower), a boron-selective ion exchange resin tower, and the like.

In the technique of the disclosure, the second filter 36 and the deionizer 38 are provided on the downstream side of the ultraviolet irradiater 32, so that a desalination treatment can be performed on the water to be treated.

The primary purification system 16 is a purification system that obtains primary pure water by removing impurities by performing a necessary treatment (cleaning treatment) on the water to be treated in this manner. That is, the primary purification system 16 includes the water treater 24, and forms a pure water producer that obtains pure water from the water to be treated by the water treater 24.

The primary pure water obtained by the primary purification system 16 is supplied to the pure water tank 18. The pure water tank 18 is a container that temporarily stores the primary pure water obtained by the primary purification system 16.

The primary pure water stored in the pure water tank 18 is sent to the secondary purification system 20.

The secondary purification system 20 has, for example, an ultraviolet irradiater, a membrane degasser, an ion exchanger (all not illustrated), and the like. The secondary purification system 20 is a purification system that further performs a necessary treatment (cleaning treatment) on the water to be treated to remove impurities and obtains secondary pure water, that is, ultrapure water.

The obtained ultrapure water is sent to the use point 22 and used as cleaning water in, for example, a semiconductor producer.

The water treater 24 includes a controller. The controller includes a processor, a memory, a storage, an input/output port, and the like. These processor, memory, storage, input/output port, and the like are electrically coupled by a bus. The storage stores a control program for controlling the water treater 24. This control program is called from the storage to the memory and developed, and executed by the processor, whereby the water treater 24 is controlled.

In the present embodiment, the first filter 26, the first injector 28, the second injector 30, the ultraviolet irradiater 32, the third injector 34, the second filter 36, and the deionizer 38 are coupled to the input/output port of the controller.

Next, a function of the water treater 24 and a water treatment method of the present embodiment will be described.

In the water treatment method using the water treater 24, the water to be treated pretreated by the pre-treater 14 is sent to the primary purification system 16. The water to be treated is not subjected to a degassing treatment, and oxygen is dissolved in the water to be treated.

If necessary, the controller adds a pH adjusting agent to the water to be treated that has passed through the first filter 26 by the first injector 28, and sets the pH of the water to be treated to a range from 6 to 8. As an example, when the pH of the water to be treated is in a range from 5 to 6, as described above, NaOH is used as the pH adjusting agent, and the pH after addition of NaOH is set in a range from 6 to 8. When the pH of the water to be treated is 9 or more, hydrochloric acid, sulfuric acid, or the like is added as the pH adjusting agent.

Thereafter, the controller adds a reducing agent to the water to be treated by the second injector 30. Sodium sulfite (Na₂SO₃), sodium bisulfite (NaHSO₃), or sodium sulfamate (NH₂OSO₂Na) is used as the reducing agent in the present embodiment as described above.

Next, the controller irradiates the water to be treated with ultraviolet rays by the ultraviolet irradiater 32. By the action of the irradiated ultraviolet ray, a radical such as persulfuric acid is generated from the reducing agent, and urea in the water to be treated is decomposed by the radicals.

An irradiation amount of ultraviolet rays to the water to be treated can be from 0.05 kW·H/m³ to 2 kW·H/m³. By setting the irradiation amount of ultraviolet rays to 0.05 kW·H/m³ or more, it is possible to irradiate the water to be treated with a sufficient amount of ultraviolet rays and reliably decompose urea. By setting the irradiation amount of ultraviolet rays to 2 kW·H/m³ or less, excessive ultraviolet irradiation is not performed, so that cost reduction can be achieved.

Thereafter, the controller adds a reducing agent to the water to be treated by the third injector 34. In the present embodiment, as described above, sodium sulfite (Na₂SO₃), sodium bisulfite (NaHSO₃), or sodium sulfamate (NH₂OSO₂Na) is used as the reducing agent. As a result, when the oxidizing agent remains in the water to be treated, the water to be treated is subjected to a reduction treatment by the reducing agent. However, the addition of the reducing agent by the third injector 34 may be omitted depending on the amount of the oxidizing agent 10) remaining in the water to be treated.

Thereafter, by passing the water to be treated through the second filter 36, some of foreign substances in the water to be treated is further removed.

Then, the primary purification system 16 performs a necessary treatment (cleaning treatment) on the water to be treated to remove impurities, and primary pure water can be obtained.

The primary pure water obtained by the primary purification system 16 is supplied to the pure water tank 18. The pure water tank 18 is a container that temporarily stores the primary pure water obtained by the primary purification system 16.

The primary pure water stored in the pure water tank 18 is sent to the secondary purification system 20, and further subjected to a necessary treatment (cleaning treatment) to obtain ultrapure water.

As can be seen from the above description, in the present embodiment, a reducing agent is added to the water to be treated in which oxygen is dissolved, and then ultraviolet rays are irradiated. Accordingly, urea in the water to be treated can be effectively decomposed.

In the present embodiment, examples of the reducing agent include at least one of sodium sulfite (Na₂SO₃), sodium bisulfite (NaHSO₃), or sodium sulfamate (NH₂OSO₂Na). All of them have a sulfur component, and can generate a persulfuric acid radical by ultraviolet irradiation, so that the water to be treated containing urea can be effectively treated.

An addition concentration of the reducing agent is, for example, from 7 ppm to 30 ppm. By setting the addition concentration of the reducing agent to 7 ppm or more, urea can be effectively decomposed. When the addition concentration of the reducing agent exceeds 30 ppm, the decomposition efficiency of urea is deteriorated. By setting the addition concentration of the reducing agent to 17 ppm or less, it is possible to suppress inadvertent remaining of the reducing agent in the water to be treated.

In the present embodiment, as described above, when at least one of sodium sulfite (Na₂SO₃), sodium bisulfite (NaHSO₃), or sodium sulfamate (NH₂OSO₂Na) is included as a reducing agent, the urea removal rate is increased.

Next, the technique of the disclosure will be described in more detail by way of examples. However, the technique of the present disclosure is not limited to the contents of the following examples.

### Examples

An actual example of decomposing urea from water to be treated using the water treater 24 of the first embodiment will be described. Table 1 indicates, as Examples 1 to 3 and Comparative Examples 1 to 4, urea removal rates according to the type and addition concentration of an additive added by the second injector 30 and the pH of the water to be treated.

TABLE 1

| | | Addition | | Urea |
|---|---|---|---|---|
| | | Concentration | | Removal |
| | Type of Additive | ppm | pH | Rate % |
| Example 1 | Na₂SO₃ | 15 | 7.5 | 86.3 |
| | Sodium Sulfite | | | |
| Example 2 | NH₂OSO₂Na | 15 | 7.7 | 66.0 |
| | Sodium Sulfamate | | | |
| Example 3 | NaHSO₃ | 15 | 7.5 | 85.2 |
| | Sodium Bisulfite | | | |
| Comparative | None | 0 | 7.6 | 3.9 |
| Example 1 | | | | |
| Comparative | ClHNNaO₃S | 15 | 7.5 | 10.6 |
| Example 2 | Sodium Chlorosulfamate | | | |
| Comparative | Na₂SO₄ | 15 | 7.5 | 25.5 |
| Example 3 | Sodium Sulfate | | | |
| Comparative | NaNO₂ | 15 | 7.5 | 16.0 |
| Example 4 | Sodium Nitrite | | | |

As the water to be treated, water was used which was treated by passing Atsugi City water (tap water) through an atmospheric pressure degassing tower operated at pH=5.5, further adjusting the pH to 7.5, and passing it through a reverse osmosis membrane (first filter 26), and urea was added to this water so that a urea concentration was 80 ppb. The atmospheric pressure degassing tower was operated at a gas-liquid ratio (G/L)=5. As the reverse osmosis membrane, ESPA-LD MAX manufactured by Nitto Denko Corporation was used. A carbonic acid concentration of the water to be treated supplied to the ultraviolet irradiater 32 after a degassing treatment was 0.1 ppm or less, and a dissolved oxygen amount was 8 ppm. The dissolved oxygen amount of the water to be treated was measured with an Orbisphere 510 dissolved oxygen meter manufactured by Hach Company.

As the ultraviolet irradiater 32, NPU-1/2 manufactured by Japan Photo Science Co., Ltd. was used, and water to be treated was passed through at 0.4 l/min. As the pH adjusting agent, sodium hydroxide (NaOH) or sulfuric acid (H₂SO₄) was used. The pH of the water to be treated was measured at an inlet part of the ultraviolet irradiater 32.

In the calculation of the urea removal rate, the urea concentration was measured by a LS/MS/MS system (4000 QTRAP manufactured by SCIEX) at an outlet position of the ultraviolet irradiater 32, and the urea removal rate was calculated from the measured value and 80 ppb as the addition concentration.

When sodium sulfite was used as the reducing agent as in Example 1, the urea removal rate was high in the table. Even when sodium sulfamate was used as the reducing agent as in Example 2, the urea removal rate was second highest after Example 1 in the table. As described above, when the urea removal rate is about 60% or more, it can be said that urea is sufficiently removed. Example 3 is an example under the same conditions as in Example 1 except that sodium bisulfite was used as the reducing agent instead of sodium sulfite in Example 1. In the case of Example 3, substantially the same results as in Example 1 were obtained.

On the other hand, when the reducing agent is not added as in Comparative Example 1, the urea removal rate is low even though the pH value is large. When sodium chlorosulfamate was used as an additive (oxidizing agent) as in Comparative Example 2, the urea removal rate is low even though the pH value is high.

Comparative Example 3 is a case where sodium sulfate that is neither a reducing agent nor an oxidizing agent was used as an additive, and the pH value was high. In this case, the urea removal rate is higher than that in Comparative Example 2, but is lower than that in Example 2.

Comparative Example 4 is a case where sodium nitrite, which is a kind of a reducing agent, was added as an additive. In this case, a urea decomposition rate is low.

From the above results, it is considered that in the technique of the disclosure, a persulfuric acid radical or an oxidizing agent in a form close thereto is generated in the urea decomposition to act on the urea decomposition. It is considered to suggest that a reducing atmosphere is preferable or addition of a reducing agent including a sulfur component is preferable in order to generate this component. Therefore, examples of the reducing agent include sodium sulfite, sodium bisulfite, sodium sulfamate, sodium pyrosulfite, sodium disulfite, sodium bisulfite, sodium thiosulfite, and alkali metal salts thereof such as potassium. As these reducing agents, commercially available aqueous solutions may be used.

As the reducing agent, sodium sulfite, sodium bisulfite, and sodium sulfamate are more preferable, and sodium sulfite and sodium bisulfite are still more preferable in order to obtain a high urea removal rate.

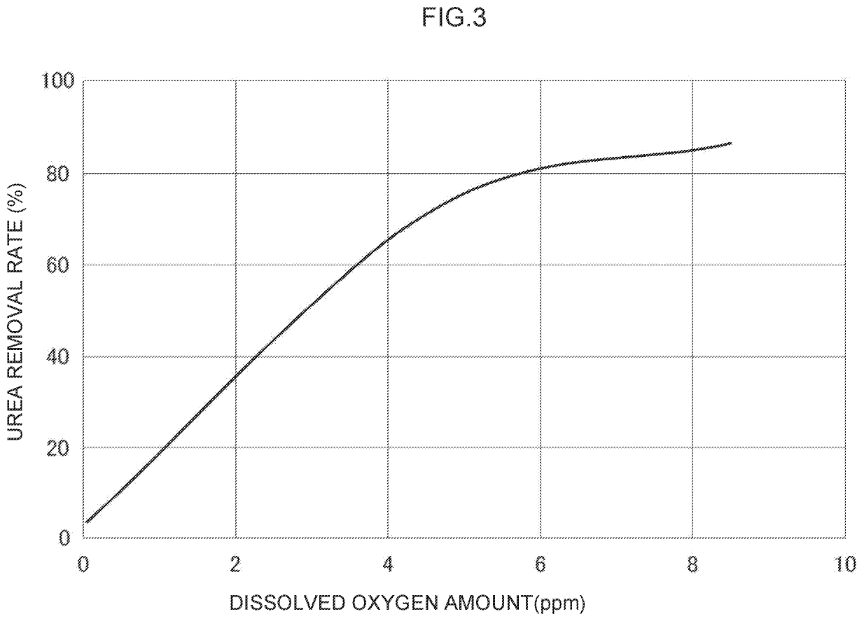

In the technique of the disclosure, a high urea removal rate can be obtained by increasing the dissolved oxygen amount of the water to be treated. From such a viewpoint, FIG. 3 illustrates urea removal rates when the dissolved oxygen amount of the water to be treated is changed in Example 1.

From this graph, it can be seen that the higher the dissolved oxygen amount of the water to be treated is, the higher the urea removal rate is. In particular, it can be seen that when the dissolved oxygen amount is about 3 ppm or more and a saturated concentration is 8 ppm or less, a value of 50% or more can be obtained as the urea removal rate.

From this result, it is considered that in decomposition of urea, a reducing agent including a sulfur component reacts with oxygen to generate an active species (possibly a persulfuric acid radical or an oxidizing agent in a form close thereto).

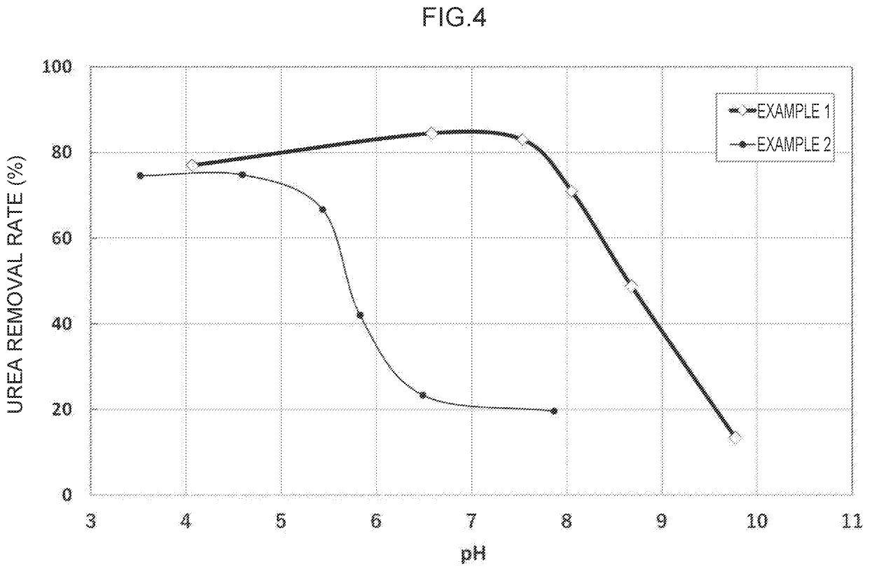

FIG. 4 illustrates an example of an experimental result performed for the relationship between the pH of the water to be treated and the urea removal rate. Experimental Example 1 in FIG. 4 is a result of an experiment on how the urea removal rate changes by appropriately adjusting the pH adjusting agent to change the pH under the same conditions as in Example 1 indicated in Table 1. Experimental Example 2 in FIG. 4 is a case where the same treatment was performed on Experimental Example 1 except that the treatment by a degassed film was not performed. In Experimental Example 1, carbonic acid in the water to be treated was almost removed (1 ppm or less), whereas in Experimental Example 2, the carbonic acid concentration was 4 ppm.

From Experimental Example 1, it can be seen that when carbonic acid is almost removed from the water to be treated, the pH of the water to be treated is preferably from 5.0 to 7.7, and more preferably from 6.5 to 7.5 in order to efficiently perform urea decomposition.

From Experimental Example 2, it can be seen that when carbonic acid is not removed from the water to be treated, the pH of the water to be treated is preferably from 3.0 to 5.0 in order to efficiently perform urea decomposition. This is considered to be because when carbonic acid in the water to be treated exists as carbonate ions or bicarbonate ions, these ions function as a scavenger (scavenger) and consume the generated sulfuric acid radical.

An object of the disclosure is to efficiently remove urea from water to be treated.

In a water treatment method of a first aspect, a reducing agent is added to water to be treated, and the water to be treated to which the reducing agent has been added is irradiated with ultraviolet rays to decompose urea.

In this water treatment method, urea is decomposed by irradiating the water to be treated with ultraviolet rays. In this water treatment method, a reducing agent is added to the water to be treated before ultraviolet irradiation. As described above, by adding the reducing agent to the water to be treated and then performing ultraviolet irradiation, urea can be efficiently removed from the water to be treated as compared with a configuration in which such a series of treatments is not performed.

In a water treatment method of a second aspect, in the first aspect, the reducing agent includes at least one of sodium sulfite, sodium bisulfite, or sodium sulfamate.

When the reducing agent includes at least one of sodium sulfite, sodium bisulfite, or sodium sulfamate, urea can be effectively decomposed.

In a water treatment method of a third aspect, in the first or second aspect, an addition concentration of the reducing agent is from 7 ppm to 30 ppm.

By setting the addition concentration of the reducing agent to 7 ppm or more, urea can be effectively decomposed.

By setting the addition concentration of the reducing agent to 30 ppm or less, deterioration in decomposition efficiency of urea can be suppressed.

In a water treatment method according to a fourth aspect, in any one of the first to third aspects, a desalination treatment is performed on the water to be treated after being irradiated with the ultraviolet rays.

By performing the desalination treatment, some of an ionic component can be removed from the water to be treated.

In a water treatment method according to a fifth aspect, in any one of the first to fourth aspects, a dissolved oxygen amount of the water to be treated when being irradiated with the ultraviolet rays is from 3 ppm to 8 ppm.

The urea removal rate can be increased as compared with the case of irradiating the water to be treated having a dissolved oxygen amount of less than 3 ppm with ultraviolet rays.

As compared with the case where the dissolved oxygen amount of the water to be treated when being irradiated with ultraviolet rays is more than 8 ppm, excessive oxygen does not remain in the water after being treated by this water treatment method.

A water treater according to a sixth aspect has a reducing agent injector configured to add a reducing agent to water to be treated, and an ultraviolet irradiater configured to irradiate the water to be treated to which the reducing agent has been added with ultraviolet rays to decompose urea.

In this water treater, urea is decomposed by irradiating the water to be treated with ultraviolet rays by the ultraviolet irradiater, but the reducing agent is added to the water to be treated by the reducing agent injector before the ultraviolet irradiation. As described above, by adding the reducing agent to the water to be treated and then performing ultraviolet irradiation, urea can be efficiently removed from the water to be treated as compared with a configuration in which such a series of treatments is not performed.

A pure water production system of a seventh aspect has the water treater according to the sixth aspect, and a pure water producer configured to produce pure water by removing impurities from the water to be treated by the water treater.

Since the water treater of the sixth aspect is provided, urea can be removed from the water to be treated at a high urea removal rate. The pure water produced by the pure water producer is also pure water from which urea is removed at a high urea removal rate.

In the technique of the disclosure, urea can be efficiently removed from water to be treated.

What is claimed is:

1. A water treatment method, comprising:
adding a reducing agent to water to be treated, by a reducing agent injector; and
irradiating the water to be treated to which the reducing agent has been added with ultraviolet rays to decompose urea, by an ultraviolet irradiater.

2. The water treatment method according to claim 1, wherein the reducing agent includes at least one of sodium sulfite, sodium bisulfite, or sodium sulfamate.

3. The water treatment method according to claim 1, wherein an addition concentration of the reducing agent is from 7 ppm to 30 ppm.

4. The water treatment method according to claim 1, wherein a desalination treatment is performed on the water to be treated after being irradiated with the ultraviolet rays.

5. The water treatment method according to claim 1, wherein a dissolved oxygen amount of the water to be treated at the time of irradiating the ultraviolet rays is from 3 ppm to 8 ppm.

6. A water treater, comprising:
a reducing agent injector configured to add a reducing agent to water to be treated; and
an ultraviolet irradiater configured to irradiate the water to be treated to which the reducing agent has been added with ultraviolet rays to decompose urea.

7. A pure water production system, comprising:
the water treater according to claim 6; and
a pure water producer configured to produce pure water by removing impurities from the water to be treated that has been treated by the water treater.
